(19) United States
(12) Patent Application Publication
(10) Pub. No.: US 2026/0118465 A1
(43) Pub. Date: Apr. 30, 2026

(54) STAR SENSOR OPTICAL SYSTEM AND STAR SENSOR

(71) Applicants: Tsinghua University, Beijing (CN); HON HAI PRECISION INDUSTRY CO., LTD., New Taipei (TW)

(72) Inventors: JUN ZHU, Beijing (CN); XIAO-HENG WANG, Beijing (CN); XIN-ROU CHEN, Beijing (CN); ZHI-KUN LI, Beijing (CN)

(21) Appl. No.: 18/913,026

(22) Filed: Oct. 11, 2024

(30) Foreign Application Priority Data
Oct. 17, 2023 (CN) 202311348531.5

(51) Int. Cl. G01S 3/786; G02B 19/00

(52) U.S. Cl. CPC G01S 3/7867; G02B 19/0076

(57) ABSTRACT

A star sensor optical system comprises a plurality of lenses. A focal length of the star sensor optical system gradually decreases from a central field of view to a peripheral field of view.

### CROSS-REFERENCE TO RELATED APPLICATIONS

This application claims all benefits accruing under 35 U.S.C. § 119 from China Patent Application No. 202311348531.5, filed on Oct. 17, 2023, in the China National Intellectual Property Administration, the contents of which are hereby incorporated by reference.

### FIELD

The present disclosure relates to the field of optics, and in particular to a star sensor optical system and a star sensor.

### BACKGROUND

A star sensor is a sensor used for attitude measurement of satellites and other spacecraft. By acquiring star images within a certain spatial range through a star sensor, processing the acquired images, and comparing the acquired images with the existing star image database, the relative position of the stars can be determined, thereby determining the instantaneous attitude information of the spacecraft, and performing attitude adjustment and control.

The star sensor consists of an optical system, a detector, and a signal processing unit, wherein the optical system is used to capture star images. The light beam emitted by the star is focused on the detection surface after passing through the optical system. After obtaining the star map, the position vector of the star point is obtained through an algorithm. And using the angular distance and other information of the observed star map, feature matching is performed with the navigation star catalog to identify the star map. Finally, based on the relative position vector information of the star map, the attitude information of the spacecraft is calculated.

The optical system and the detector jointly determine the effect of projecting the star map. Among them, the larger the field of view of the optical system, the larger the spatial range that can be photographed, and the more stars can be photographed. The focal length of the optical system and the pixel size of the detector jointly determine the measurement accuracy of an individual star. After the detector is determined, the larger the focal length, the higher the measurement accuracy of the individual start. Conventional star sensor optical systems have a medium or a lower field of view, and the image height of a star on the detector is: Y=f*tan θ, where θ is the angle between the target direction and the optical axis, f is the focal length of the optical system, and Y is the imaging height. The spatial range observed by the optical system of a star sensor is constrained by the chip size Y of the detector and the focal length f of the system. Under the premise that the detector is determined, increasing the field of view of the optical system will reduce the focal length of the system. That is, while expanding the range of star capture, the positioning accuracy of an individual star will decrease. At the same time, if the focal length is increased to improve the positioning accuracy of an individual star, the field of view of the optical system will become smaller, and the number of stars that can be photographed will decrease.

### BRIEF DESCRIPTION OF THE DRAWINGS

Implementations of the present technology will now be described, by way of example only, with reference to the attached figures, wherein:

FIG. 1 is a schematic diagram of the structure of a star sensor provided by the present disclosure.

FIG. 2 is a schematic diagram of the structure of an optical system in a star sensor provided by a first embodiment of the present disclosure.

FIG. 3 is a diagram of measurement accuracy of an individual start of a star sensor provided by the first embodiment of the present disclosure.

FIG. 4 is a diagram of the energy concentration of an optical system in the star sensor provided by the first embodiment of the present disclosure.

FIG. 5 is a schematic diagram of the structure of an optical system in a star sensor provided by a second embodiment of the present disclosure.

FIG. 6 is a diagram of the energy concentration of an optical system in the star sensor provided by the second embodiment of the present disclosure.

FIG. 7 is a schematic diagram of the structure of an optical system in a star sensor provided by a third embodiment of the present disclosure.

FIG. 8 is a diagram of the energy concentration of an optical system in the star sensor provided by the third embodiment of the present disclosure.

FIG. 9 is a schematic diagram of the structure of an optical system in a star sensor provided by a fourth embodiment of the present disclosure.

FIG. 10 is a diagram of the individual star measurement accuracy of the star sensor provided by the fourth embodiment of the present disclosure.

FIG. 11 is a diagram of the energy concentration of an optical system in the star sensor provided by the fourth embodiment of the present disclosure.

### DETAILED DESCRIPTION

The disclosure is illustrated by way of example and not by way of limitation in the figures of the accompanying drawings in which like references indicate similar elements. It should be noted that references to “another,” “an,” or “one” embodiment in this disclosure are not necessarily to the same embodiment, and such references mean “at least one.”

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts have been exaggerated to illustrate details and features of the present disclosure better.

Several definitions that apply throughout this disclosure will now be presented.

The term “substantially” is defined to be essentially conforming to the particular dimension, shape, or other feature which is described, such that the component need not be exactly or strictly conforming to such a feature. The term “comprise,” when utilized, means “comprise, but not necessarily limited to”; it specifically indicates open-ended inclusion or membership in the so-described combination, group, series, and the like. The term of “first”, “second” and the like, are only used for description purposes, and should not be understood as indicating or implying their relative importance or implying the number of indicated technical features. Thus, the features defined as “first”, “second” and the like expressly or implicitly comprise at least one of the features. The term of “multiple times” means at least two times, such as two times, three times, etc., unless otherwise expressly and specifically defined.

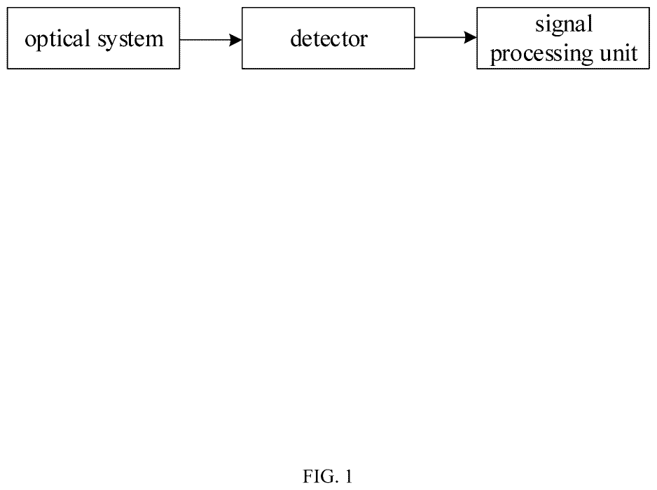

Referring to FIG. 1, a star sensor comprises an optical system, a detector and a signal processing unit. The optical system is configured to capture the star image in space, transmit the signal radiated by the star to the detector, and the detector performs photoelectric conversion on the focused light signal and outputs a star map. The signal processing unit performs target extraction, coordinate conversion and repositioning on the star map. The processed star map is compared with the navigation star catalog, the acquired star map is identified, and finally the attitude angle of the spacecraft is obtained.

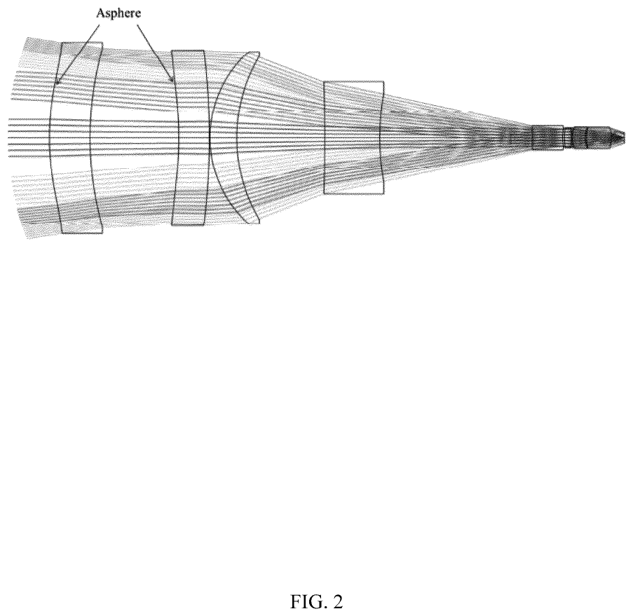

A first embodiment of the present disclosure provides a star sensor. Please refer to FIG. 2, an optical system in the star sensor is a transmission optical system comprising eight lenses. The eight lenses comprise a first lens and a second lens. Front surfaces of the first lens and the second lens in the optical system are aspherical, and the focal length of the optical system gradually decreases from a central field of view to an edge field of view, that is, the focal length of the optical system is the largest in the central field of view and the smallest in the edge field of view. A comparison of the relevant optical parameters of the optical system and the traditional optical system is shown in Table 1. Under the condition of consistent image height in the whole field of view, the star sensor of this embodiment can increase the field of view from 10.8° to 18°, which greatly improves a capture space of the star sensor for stars.

TABLE 1

| | Conventional | Star sensor of the |
|---|---|---|
| | star sensor | first embodiment |
| Band | 480 nm~650 nm | 480 nm~650 nm |
| Full field of view | 1.05 mm | 1.05 mm |
| image height | | |
| Central field of view | 9.5 mm | 9.5 mm |
| entrance pupil | | |
| Central field of view | 14.3 mm | 15 mm |
| focal length | | |
| Field of view angle | 10.8° | 18° |

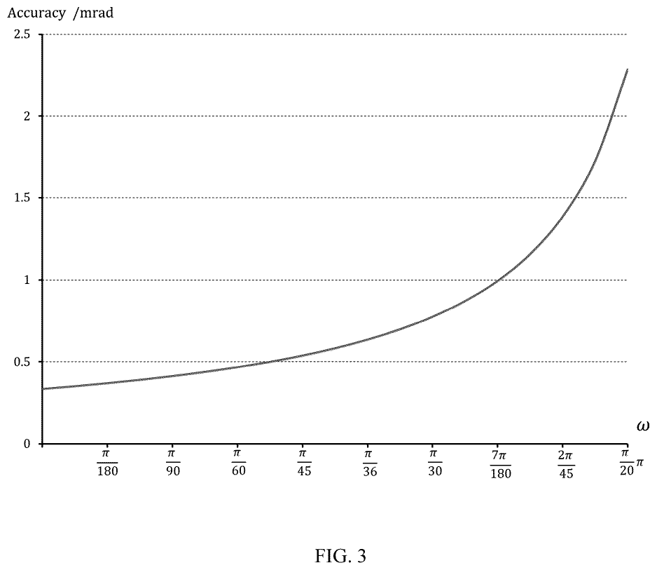

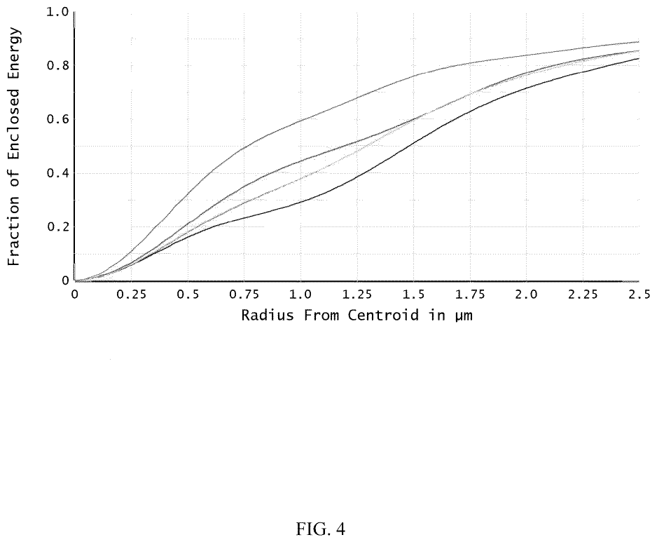

Please refer to FIG. 3, which shows the individual star measurement accuracy of the star sensor of the first embodiment. The individual star measurement accuracy gradually decreases from the central field of view to the edge field of view. The individual star measurement accuracy of the central field of view is 0.33 mrad, which meets the accuracy requirements of attitude measurement. The MTF of the optical system of the star sensor of this embodiment can reach more than 0.65 at the next frequency of 100 lp/mm, indicating that the optical system has good imaging contrast. Please refer to FIG. 4, which is a diagram of the energy concentration of the optical system of the star sensor in this embodiment. Energy concentration characterizes the star sensor's ability to converge starlight. The higher the energy proportion on a single pixel, the easier it is to locate the centroid of the star point. More than 82% of the energy is concentrated in a circle with a radius of 2.5 μm, which is conducive to the later sub-pixel centroid positioning.

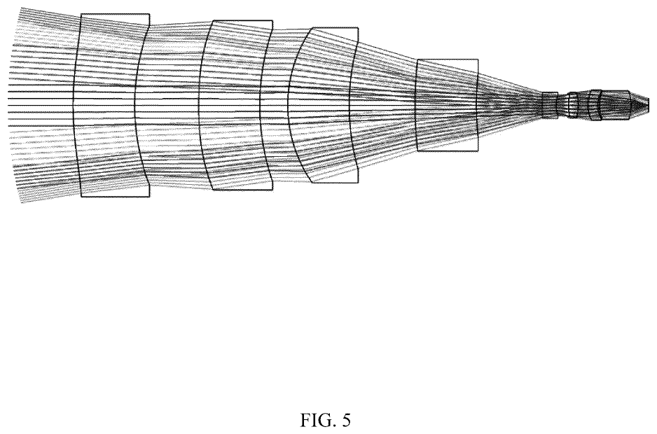

A second embodiment of the present disclosure provides a star sensor. Please refer to FIG. 5, the optical system in the star sensor has a coaxial transmission optical system with rotational symmetry characteristics, which is composed of eight lenses, wherein the front surface of the first lens is an aspherical lens. The focal length f of the optical system is 10 mm, the F # is 1.58, the half image height Y corresponding to the half field angle is 1.05 mm, and the half field angle θ is 9°. If the imaging relationship of the optical system adopts the relationship of Y=f*tan θ, the half field angle corresponding to the image height of 1.05 mm is 6°. Table 2 lists the difference in field of view between the conventional optical system and the optical system of this embodiment when the focal length and image height are the same. It can be seen from Table 2 that the field of view of the star sensor of this embodiment is significantly increased, and the increase in the field of view can effectively increase the spatial range of detection, thereby increasing the number of stars captured.

TABLE 2

| | Conventional | Star sensor of the |
|---|---|---|
| | star sensor | second embodiment |
| Band | 480 nm~650 nm | 480 nm~650 nm |
| Full field of view | 1.05 mm | 1.05 mm |
| image height | | |
| Focal length | 10 mm | 10 mm |
| Full field of view angle | 12° | 18° |

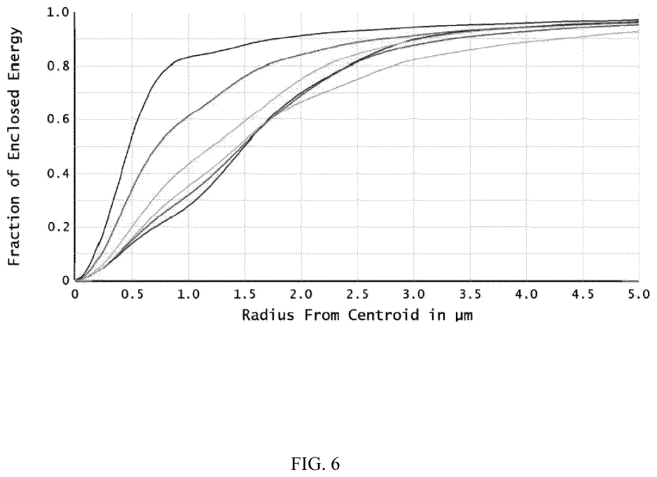

Comparing the imaging position of the image plane of the traditional optical system with the imaging position of the optical system shown in this embodiment, it is found that the resolution of the optical system of this embodiment and the traditional optical system in the central field of view is consistent. Under the same image plane size, this embodiment can observe a larger field of view space. Please refer to FIG. 6, which is a diagram of the energy concentration of the optical system of the star sensor of this embodiment. The detector pixel size is set to 10 μm. Under each field of view angle, more than 90% of the energy is concentrated in one pixel, indicating that the star sensor of this embodiment has a good starlight collection effect.

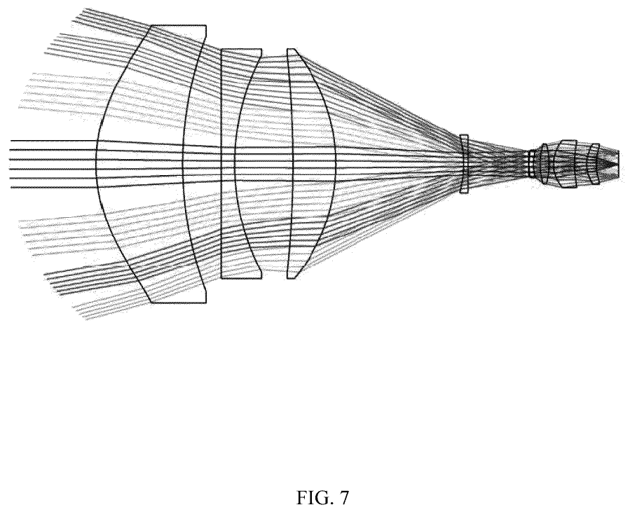

Please refer to FIG. 7, a third embodiment of the present disclosure provides a star sensor. The optical system of the star sensor is a transmissive optical system composed of eight lenses. The focal length f of the optical system is 20 mm, F # is 1.83, the half-viewing angle corresponds to the half-image height Y of 3.17 mm, and the half-viewing angle θ is 15°. If the optical system adopts the imaging relationship of Y=f*tan θ, then when the half-viewing angle θ is 15° and the half-image height Y is 3.17 mm, the focal length f of the traditional optical system is only 11 mm. Compared with the optical system of this embodiment, the individual star positioning accuracy of the central field of view of the traditional optical system is lower. Table 3 lists the difference in focal length between the star sensor of this embodiment and the traditional star sensor when the field angle and image height are the same.

TABLE 3

| | Conventional | Star sensor of the |
|---|---|---|
| | star sensor | third embodiment |
| Band | 480 nm~650 nm | 480 nm~650 nm |
| Full field of view | 6.34 mm | 6.34 mm |
| image height | | |
| Focal length | 30° | 30° |
| Full field of view angle | 11 mm | 20 mm |

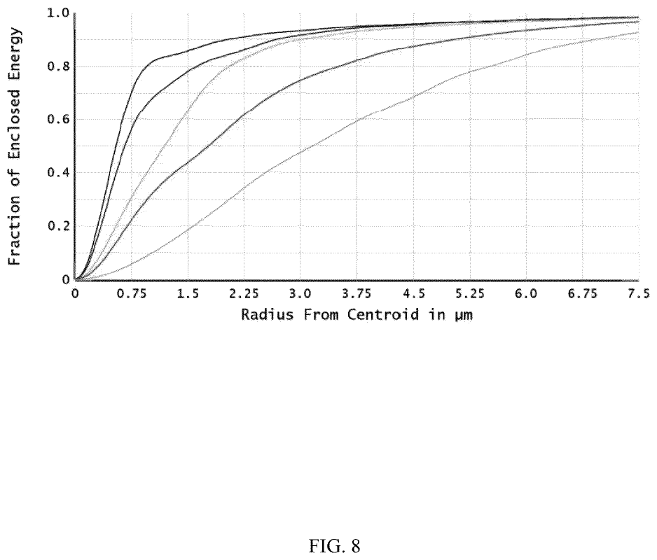

The focal length of the central field of view of the star sensor optical system shown in this embodiment is 1.82 times that of the traditional optical system. The individual star positioning accuracy of the central field of view of the star sensor is proportional to the focal length of the optical system. Therefore, the individual star positioning accuracy of the central field of view of the star sensor of this embodiment is 1.82 times that of the traditional star sensor. The star sensor of this embodiment greatly improves the individual star positioning accuracy of the central field of view while keeping the field of view angle and the detector size unchanged. Please refer to FIG. 8, which is a diagram of the energy concentration of the optical system of the star sensor of this embodiment. The detector pixel size is set to 15 μm. At each field of view angle, more than 90% of the energy can be concentrated in one pixel, indicating that the star sensor of this embodiment has a good starlight collection effect.

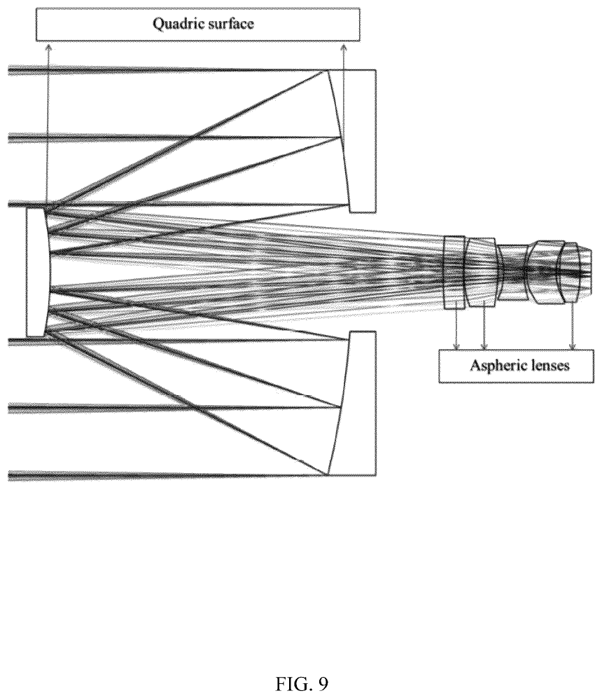

Please refer to FIG. 9, A fourth embodiment of the present disclosure provides a star sensor. The optical system of the star sensor is an R-C refractive optical system, which is composed of three reflectors and five lenses. The surface types of the two reflectors in the optical system are quadratic surfaces, and the surface types of the first two lenses and the last lens are double-sided aspherical surfaces.

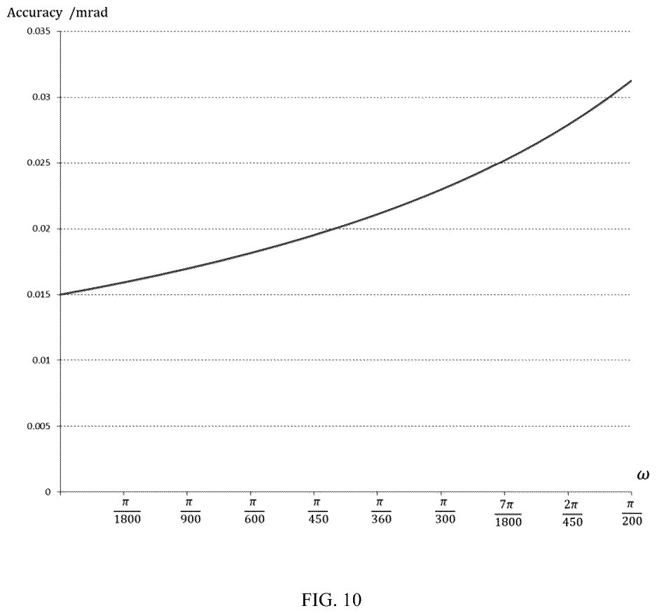

Table 4 shows the relevant parameters of the traditional R-C optical system and the R-C optical system of this embodiment. The R-C optical system of this embodiment improves the focal length of the central field of view while maintaining the detection space. FIG. 10 shows the individual star measurement accuracy of the star sensor of this embodiment. The individual star measurement accuracy of the central field of view reaches 0.015 mrad, which is greatly improved compared with the traditional star sensor, which can improve the attitude solution accuracy of the spacecraft.

TABLE 4

| | Conventional | Star sensor of the |
|---|---|---|
| | star sensor | fourth embodiment |
| Band | 480 nm~650 nm | 480 nm~650 nm |
| Full field of view | 18.6 mm | 18.6 mm |
| image height | | |
| Aperture | 170 mm | 170 mm |
| Field of view | 1.8° | 1.8° |
| Center field of | 592 mm | 800 mm |
| view focal length | | |

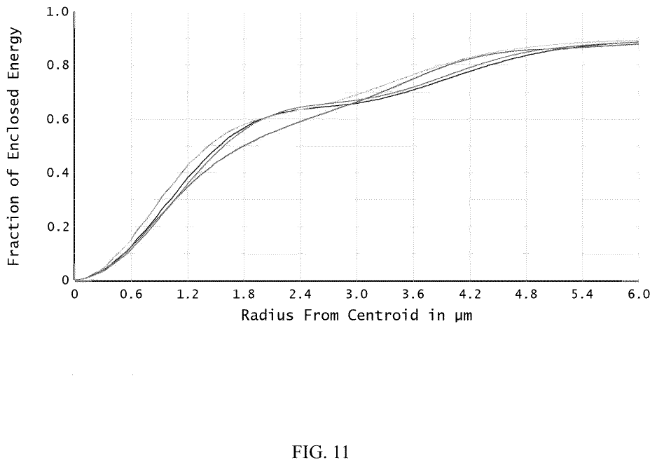

Please refer to FIG. 11, which is a diagram of the energy concentration of the optical system of the star sensor of this embodiment. The MTF of the optical system of the star sensor of this embodiment at the Nexter frequency is greater than 0.75, and more than 87% of the energy of each field of view can be concentrated within a single pixel. This shows that the star sensor of this embodiment has good imaging quality and can improve the individual star measurement accuracy.

It can be understood that the optical system of the star sensor of the present disclosure can also adopt a reflective optical system, which is not listed here one by one.

The focal length of the optical system of the star sensor of the present disclosure is not constant but variable, and the focal length gradually decreases from the central field of view to the edge field of view. Therefore, the star sensor of the present disclosure can improve the detection field of view and the individual star measurement accuracy respectively according to the needs, and can control the individual star measurement accuracy of different fields of view respectively. By designing a reasonable focal length, the detection field of view can be expanded and the individual star measurement accuracy can be improved at the same time.

The star sensor of the present disclosure can reduce the array scale of the detector photosensitive surface while maintaining the field of view and the individual star measurement accuracy. Reducing the number of detector arrays can reduce the cost of the system, shorten the data readout time, and improve the update rate of the star sensor.

It is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

Depending on the embodiment, certain of the steps of a method described may be removed, others may be added, and the sequence of steps may be altered. The description and the claims drawn to a method may comprise some indication in reference to certain steps. However, the indication used is only to be viewed for identification purposes and not as a suggestion as to an order for the steps.

What is claimed is:

1. A star sensor optical system comprising:
a plurality of lenses, wherein a focal length of the star sensor optical system gradually decreases from a central field of view to a peripheral field of view.

2. The star sensor optical system of claim 1, wherein the plurality of lenses is arranged so that a largest focal length of the star sensor optical system is in a central field of view of the focal length of the star sensor optical system; and a smallest focal length of the star sensor optical system is in a peripheral field of view.

3. The star sensor optical system of claim 1, wherein the star sensor optical system is a transmissive optical system, a catadioptric optical system or a reflective optical system.

4. A star sensor comprising:
a star sensor optical system, a detector and a signal processing unit, wherein the star sensor optical system comprises a plurality of lenses, a focal length of the star sensor optical system gradually decreases from a central field of view of the star sensor optical system to a peripheral field of view of the star sensor optical system.

5. The star sensor of claim 4, wherein the focal length of the star sensor optical system is the largest in the central field of view and the smallest in the peripheral field of view.

6. The star sensor of claim 4, wherein the star sensor optical system is a transmissive optical system, a catadioptric optical system or a reflective optical system.

7. A star sensor comprising:
a star sensor optical system, a detector and a signal processing unit, wherein an individual star measurement accuracy of the star sensor gradually decreases from a central field of view star sensor optical system to an edge field of view star sensor optical system.
